(19) United States
(12) Patent Application Publication
(10) Pub. No.: US 2006/0072191 A1
(43) Pub. Date: Apr. 6, 2006

(54) Confocal microscope

(75) Inventors: Takashi Akiyama, Tokyo (JP); Kenta Mikuriya, Tokyo (JP); Yasuhito Kosugi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/242,871

(22) Filed: Oct. 5, 2005

(30) Foreign Application Priority Data
Oct. 6, 2004 (JP) P.2004-293278

(51) Int. Cl. G02B 21/06

(52) U.S. Cl. 359/385; 359/368

(57) ABSTRACT

In A confocal microscope, a mirror reflects illumination light to focus on a focal point face of a sample through an object lens. The mirror is rotated to scan a focal point of the illumination light. A confocal image provided based on returned light from the sample. The confocal microscope has a first multipinhole array which has a plurality of pinholes, and to which light emitted from a light source is illuminated, and a second multipinhole array which has a plurality of pinholes, and intercepts light from other than the focal point face out of the returned light from the sample. The first multipinhole array functions as a plurality of point light sources, and the illumination light is light which passes through the pinholes of the first multipinhole array.

### CROSS-REFERENCE TO RELATED APPLICATIONS

This application is based upon and claims the benefit of priority from the prior Japanese Patent Applications No. 2004-293278, filed on Oct. 6, 2004, the entire contents of which are incorporated herein by reference.

### BACKGROUND OF THE INVENTION

1. Field of the Invention

The present invention relates to a confocal microscope, in details, relates to a confocal microscope which scans laser light by rotating a mirror to provide a confocal image of a sample.

2. Description of the Related Art

A confocal microscope is for observing a sample by acquiring an image by scanning a converged light point on the sample and focusing returned light from the sample and is used for observing a physiological reaction of a live cell or observing morphology thereof in a field of a living body, biotechnology or the like or observing a surface of LSI in a semiconductor market.

FIG. 10 is a configuration view showing an example of a confocal microscope of a related art.

In FIG. 10, a light source 1 emits illumination light 2 which is laser light. A light converging optical element 3 is a one-dimensional beam expander disposed on an optical path and combined with, for example, a cylindrical lens for converging the illumination light 2 on an opening of an illumination light slit 4.

The illumination light slit 4 provides the illumination light 2 immediately after passing the opening of its own with a slender linear spatial light amount distribution. An optical element 5 for branching a light path, a mirror 6, and a double face mirror 7 successively reflect the illumination light 2 passing through the opening of the illumination light slit 4 and the reflected illumination light 2 is irradiated to a sample 9 to be observed by passing an object lens 8.

Although observation light 10 which is a fluorescent signal induced at inside of the sample 9 to be observed by the illumination light 2 tracks a reverse optical path (object lens 8→double face mirror 7→mirror 6) to return to the optical element 5 for branching the optical path, the observation light 10 is transmitted through the optical element 5 for branching the optical path by an optical property of the optical element 5 for branching the optical path without being reflected. The optical path branching optical element 5 is, for example, a dichroic mirror.

The optical path branching optical element 5 transmits the observation light 10 by a spectroscopic characteristic thereof. An observation light slit 11 subjected the observation light 10 converged onto an opening of its own performs an optical filtering to achieve a confocal effect. Here, the confocal effect is an effect of intercepting light from other than a focal point face of the sample 9 to be observed.

The observation light 10 passing through the observation light slit 11 is reflected by a mirror 12, thereafter, reflected by a relay lens 13, mirrors 14, 15 and the double face mirror 7 and is converged again on an image face 17. The observation light converged onto the image face 17 is incident on the naked eye 19 of an observer by an ocular lens 18 to form a linear observed image on the retina.

According to the configuration, by setting a rotating shaft of the double face mirror 7 in a direction orthogonal to any of an optical path between the double face mirror 7 and the mirror 6, an optical path between the double face mirror 7 and the mirror 15 and a microscope observing optical path 16, and rotating the double face mirror 7 in either of directions indicated by broken line arrow marks by constituting a rotational center by the rotating shaft, the illumination light can one-dimensionally scan on the sample 9 to be observed and at the same time, can form a two-dimensional observed image on the retina of the observer (refer to, for example, WO 92/17806 A1).

WO 92/17806 A1 is referred to as a related art.

According to the configuration, by deviating the double face mirror 7 from the optical path (by rotating the double face mirror 7 by constituting a rotational center by a pivot point 20), the normal microscope observing optical path 16 can newly be formed. Therefore, confocal observation and non-confocal observation can simply be switched to realize.

However, since the slit is used as the optical filtering element for achieving the confocal effect in the above-described confocal microscope of the related art, optical filtering in a longitudinal direction of the slit does not function. Thereby, light from other than the focal point face cannot be intercepted with regard to a direction in correspondence with the longitudinal direction of the slit at inside of an observed image face. Therefore, the confocal effect cannot be achieved.

### SUMMARY OF THE INVENTION

An object of the invention is to provide a confocal microscope which enables to achieve a confocal effect with regard to all of directions at inside of an observed image face by using a multipinhole array as an optical filtering element for achieving the confocal effect.

The invention provides the following confocal microscope.

The invention provides a confocal microscope for reflecting illumination light by a mirror to focus on a focal point face of a sample through an object lens, rotating the mirror to scan a focal point of the illumination light, and providing a confocal image based on returned light from the sample, the confocal microscope having: a first multipinhole array which has a plurality of pinholes, and to which light emitted from a light source is illuminated; and a second multipinhole array which has a plurality of pinholes, and intercepts light from other than the focal point face out of the returned light from the sample, wherein the first multipinhole array functions as a plurality of point light sources, and the illumination light is light which passes through the pinholes of the first multipinhole array.

The confocal microscope further has: a multilens array which is disposed on an optical path between the first multipinhole array and the light source, and has a plurality of microlenses which converge the light emitted from the light source, wherein multilens array is disposed at a position where each microlens corresponds to each pinhole of the first multipinhole array.

In the confocal microscope, the mirror includes a reflector at a position where a rotation axis of the mirror is located.

In the confocal microscope, the mirror is a polygonal mirror.

The confocal microscope further has: a rotation sensor which outputs a rotational position signal indicating a rotational position of the mirror; and a control section which moves at least one of the object lens and a stage on which the sample is placed in an optical axis direction, in synchronization with rotation of the mirror, based on the rotational position signal.

The confocal microscope further has: a control section which moves at least one of the object lens and a stage on which the sample is placed in an optical axis direction; a displacement sensor which outputs a displacement signal when at least one of the object lens and the stage is moved; and a mirror driving section which rotates the mirror in synchronization with a displacement between the object lens and the sample based on the displacement signal.

The confocal microscope further has: a rotation sensor which outputs a rotational position signal indicating a rotational position of the mirror; and a camera which picks up the confocal image in synchronization with rotation of the mirror based on the rotational position signal.

The confocal microscope further has: a control section which moves at least one of the object lens and a stage on which the sample is placed in an optical axis direction; a displacement sensor which outputs a displacement signal when at least one of the object lens and the stage is moved; and a camera which picks up the confocal image in synchronization with a displacement between the object lens and the sample based on the displacement signal.

The confocal microscope further has: a camera which picks up the confocal image; and a mirror driving section which rotates the mirror in synchronization with an imaging by the camera based on a synchronization signal output from the camera.

The confocal microscope further has: the camera which picks up the confocal image; and a control section which moves at least one of the object lens and a stage on which the sample is placed in an optical axis direction, in synchronization with an imaging by the camera, based on a synchronization signal output from the camera.

The confocal microscope further has: a dichroic mirror which dividing the returned light; and a plurality of cameras which picks up each confocal image based on the returned light divided by the dichroic mirror.

According to the confocal microscope, the following advantages are achieved.

Since the confocal microscope has the first multipinhole array which functions the plurality of point light sources and the second multipinhole array as optical filtering elements, the confocal microscope can achieve the confocal effect with regard to all of directions within the observed image face.

Since the confocal microscope has the microlenses for converging the laser light at the respective pinholes of the first multipinhole array, a transmittance of the laser light can be increased.

Since the reflecting surfaces of the double face mirror for scanning the focal point of the observed sample coincide with the rotation axis of the double face mirror, a beam can be reflected by an always the same optical path.

Since the polygonal mirror is used for the mirror which scans the focal point of the observed sample, a scanning speed can be increased.

Since a scanning period by the double face mirror and a period of an actuator drive signal for controlling the distance between the object lens and the observed sample can be made to coincide with each other, the observed image without non-uniformity in scanning can be provided.

Since an image taking period of the camera and a scanning period on the observed sample by the illumination light can be made to coincide with each other, the observed image without non-uniformity in scanning can be provided.

Since the image taking period of the camera and the period of the actuator drive signal for controlling the distance between the object lens and the observed sample can be made to coincide with each other, the observed image without non-uniformity in scanning can be provided.

Since the confocal microscope has the plurality of cameras which picks up each confocal image based on the returned light divided by the dichroic mirror, multicolor observation of the observed sample is realized.

### BRIEF DESCRIPTION OF THE DRAWINGS

FIG. 1 is a configuration view showing a first embodiment of a confocal microscope according to the invention;

FIG. 2 is a view showing an example of a multipinhole array applied to the confocal microscope of the invention;

FIG. 3 is a configuration view showing a second embodiment of the confocal microscope according to the invention;

FIG. 4 is a view showing an example of a multimicrolens array applied to the confocal microscope of the invention;

FIG. 5A illustrates a view showing an example of a double face mirror applied to the confocal microscope of the related art, and FIG. 5B illustrates a view showing an example of a double face mirror applied to the confocal microscope of the invention;

FIG. 6 is a configuration view showing a third embodiment of the confocal microscope according to the invention;

FIG. 7 is a configuration view showing a fourth embodiment of the confocal microscope according to the invention;

FIG. 8 is a configuration view showing a fifth embodiment of the confocal microscope according to the invention;

FIG. 9 is a configuration view showing a sixth embodiment of the confocal microscope according to the invention; and

FIG. 10 is a configuration view showing an example of a confocal microscope of a related art;

### DETAILED DESCRIPTION OF THE PREFERRED EMBODIMENTS

Embodiments of the invention will be explained in details with reference to the drawings as follows.

### First Embodiment

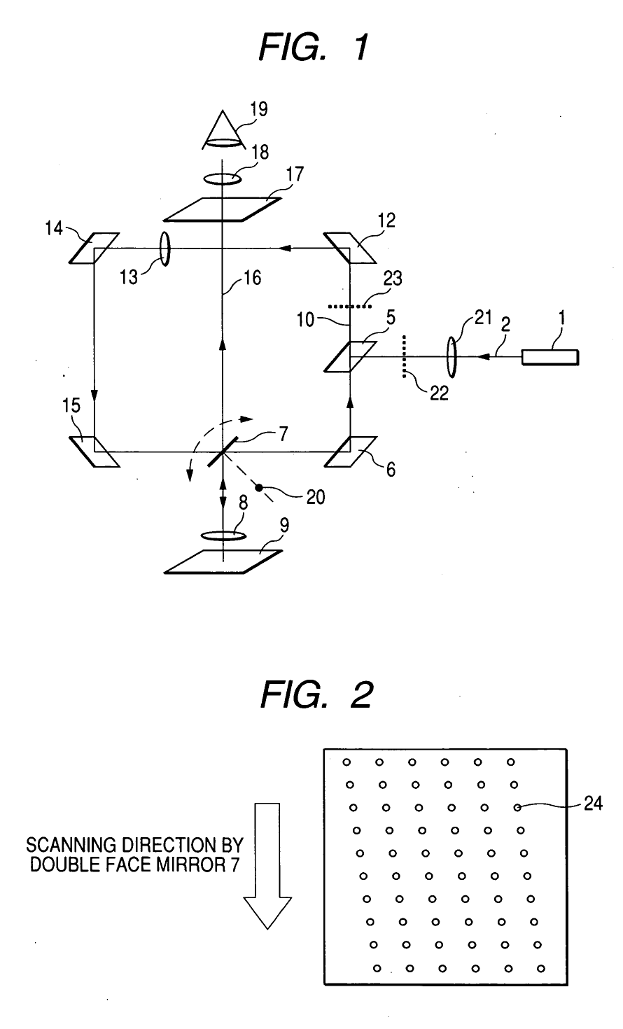

FIG. 1 is a configuration view showing a first embodiment of a confocal microscope according to the invention. Constituent elements similar to those of the previous drawing are attached with similar notations, and an explanation of the portions will be omitted.

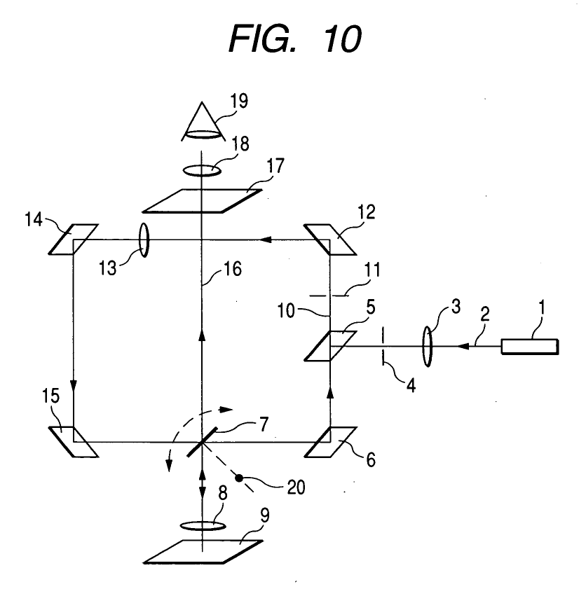

The confocal microscope of the first embodiment shown in FIG. 1 is different from the confocal microscope of the related art shown in FIG. 10 in that an illumination light multipinhole array 22 substitutes for the illumination light slit 4, an observation light multipinhole array 23 substitutes for the observation light slit 11, and an optical element 21 for expanding light ray is disposed on an optical path between the illumination light multipinhole array 22 and the light source 1.

The optical element 21 for expanding light ray is a two-dimensional beam expander combined with, for example, a convex lens for enlarging a sectional area of light ray of the illumination light 2 emitted from the light source 1 to be incident on the illumination light multipinhole array 22. As shown by FIG. 2, the illumination light multipinhole array 22 includes a plurality of pinholes and the illumination light 2 immediately after passing the pinholes 24 is regarded as light emitted respectively from point light sources. Here, the light source 1 is, for example, a laser light source.

FIG. 2 is a view showing an example of a multipinhole array applied to the confocal microscope of the invention. By shifting the pinholes to align at predetermined intervals and aligning the pinholes obliquely to a scanning direction in this way, a density of the pinholes can be increased and a scanning stroke of the double face mirror 7 can be shortened.

Referring back to FIG. 1, the illumination light 2 passing through an opening of the illumination light multipinhole array 22 is successively reflected by the optical element 5 for branching the optical path, the mirror 6, the double face mirror 7 and thereafter irradiated to the observed sample 9 by transmitting through the object lens 8. Although observation light 10 induced at inside of the observed sample 9 by the illumination light tracks the reverse optical path (object lens 8→double face mirror 7→mirror 6) to return to the optical element 5 for branching the optical path, the observation light 10 transmits through the optical element 5 for branching the optical path without being reflected by the optical property of the optical element 5 for branching the optical path and is converged onto the corresponding pinhole of the observation light multipinhole array 23.

The observation light multipinhole array 23 includes a plurality of pinholes. Each pinhole subjected incident light performs the optical filtering to achieve the confocal effect. The observation light 10 passing through the observation light multipinhole array 23 is reflected by the mirror 12, thereafter, reflected by the relay lens 23 and the mirrors 14, 15, 7 and is converged again onto the image face 17. The observation light 10 converged to the image face 17 is incident on the naked eye 19 of the observer by the ocular lens 18 to form an observed image (confocal image) of multispots on the retina.

According to the configuration, by setting the rotating shaft of the double face mirror 7 in the direction orthogonal to any of the optical path between the double face mirror 7 and the mirror 6, the optical path between the double face mirror 7 and the mirror 15 and the microscope observation light path 16 and rotating the double face mirror 7 in either of the directions indicated by the broken line arrow marks by constituting the rotational center by the rotating shaft, the illumination light of the multispots can one-dimensionally be scanned on the observed sample 9 and at the same time, the two-dimensional observed image can be formed on the retina of the observer. Further, the double face mirror 7 is rotated by a mirror driving section constituted by, for example, a DC motor and a driving apparatus for driving the motor (both of which are not illustrated).

### Second Embodiment

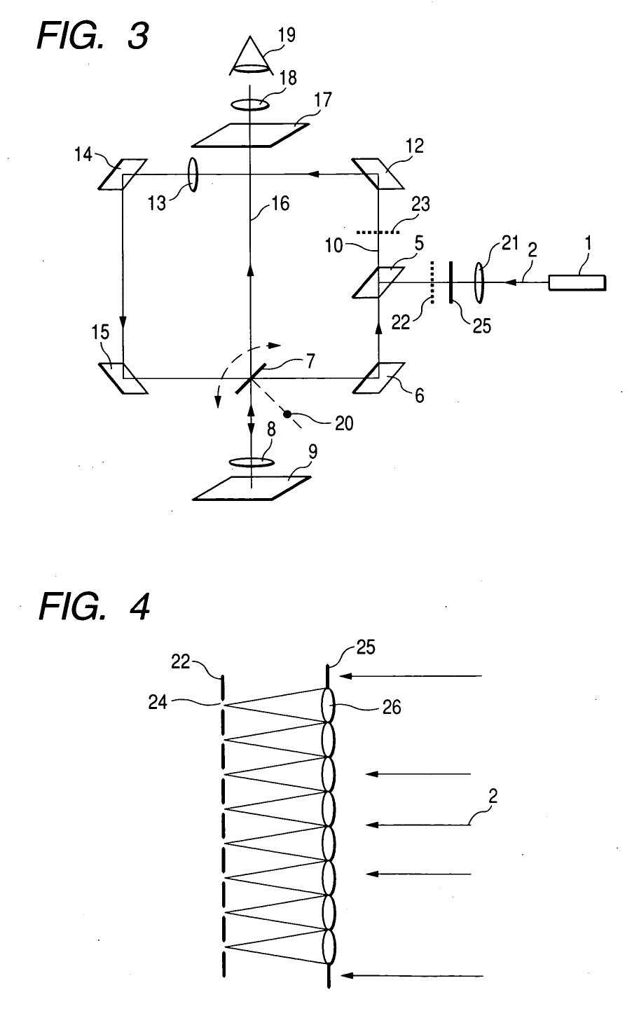

FIG. 3 is a configuration view showing a second embodiment of a confocal microscope according to the invention. Constituent elements similar to those of the previous drawings are attached with the similar notations, and an explanation thereof will be omitted.

The confocal microscope of the second embodiment shown in FIG. 3 is different from the confocal microscope of the first embodiment shown in FIG. 1 in that a multimicrolens array 25 is disposed on an optical path between the light ray expanding optical element 21 and the illumination light multipinhole array 22.

FIG. 4 is a view showing an example of a multimicrolens array applied to the confocal microscope of the invention. As shown by FIG. 4, the multimicrolens array 25 includes microlenses at positions in correspondence with the pinholes of the illumination light multipinhole array 22 and the microlenses 26 converge the illumination light 2 onto the pinholes 24. By converging the illumination light 2 onto the respective pinholes 24 of the illumination light multipinhole array 22 by the respective microlenses in this way, a transmittance of the illumination light 2 can be increased.

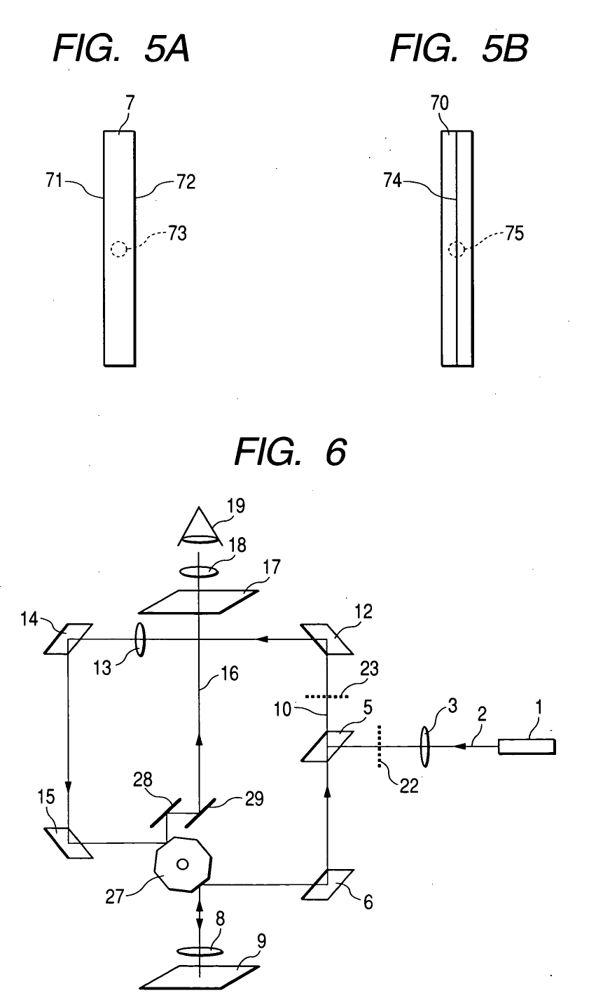

FIG. 5A illustrates a view showing an example of the double face mirror applied to the confocal microscope of the related art, whereas FIG. 5B illustrates a view showing an example of a double face mirror applied to the confocal microscope of the invention. In FIG. 5A, the double face mirror 7 is constituted by, for example, a glass member having a predetermined thickness. The double face mirror 7 shown in FIG. 5A is constructed by a configuration of providing reflecting surfaces 71, 72 on both side faces of the glass member. In this case, the reflecting surfaces 71, 72 are shifted from a mirror rotating shaft 73. Therefore, at each time of changing an angle of the double face mirror 7, portions on which light ray is incident differ and also an optical path of reflected light ray is shifted. Therefore, it is necessary to separately provide correcting means for correcting the shift of the optical path.

In contrast thereto, the double face mirror 70 shown in FIG. 5B is provided with a reflector 74 which is made to coincide with a mirror rotation axis 75 of the double face mirror 70 at inside of the glass member. When light ray is made to be incident on the rotation axis of the double face mirror 70, even when the angle of rotating the double face mirror 70 is changed, portions on which light ray is incident on remain unchanged. Therefore, a beam can be reflected always on the same optical path and the above-described correcting means is not needed.

### Third Embodiment

FIG. 6 is a configuration view showing a third embodiment of the confocal microscope according to the invention. Constituent elements similar to those of the previous drawings are attached with similar notations, and an explanation of the portions will be omitted.

The confocal microscope of the third embodiment in FIG. 6 is different from the confocal microscope of the first embodiment shown in FIG. 1 in that a polygonal mirror 27 substitutes for the double face mirror 7, and optical path bending mirrors 28, 29 are provided for adjusting the optical path in accordance therewith.

The polygonal mirror 27 is a polygonal prism having reflecting surfaces at side faces thereof. By rotating the polygonal prism around a center axis thereof, an angle of reflecting a beam incident on the side face is changed and a light converging point of a face of the observed sample is scanned. At the same time, the observation light 10 reflected from the mirror 15 is reflected by other side face. The optical path bending mirrors 28, 29 makes the observation light 10 reflected from the polygonal mirror 27 coincide with the microscope observing optical path 16.

When the polygonal mirror is used in this way, high speed scanning can be executed.

### Fourth Embodiment

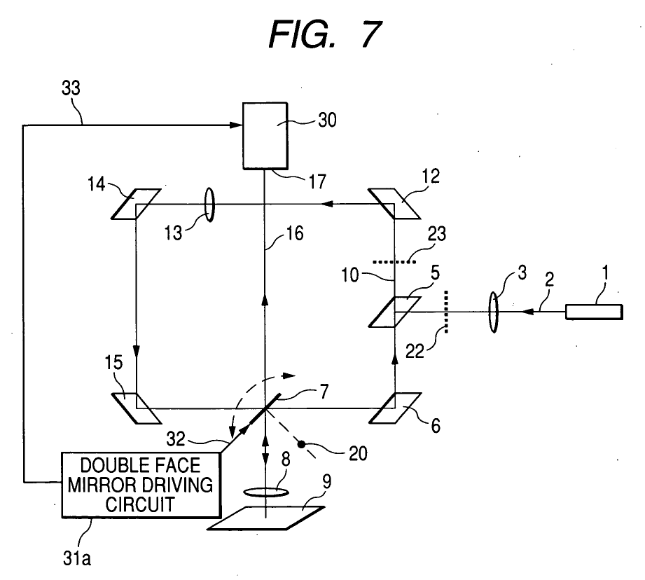

FIG. 7 is a configuration view showing a fourth embodiment of the confocal microscope according to the invention. Constituent elements similar to those of the previous drawings are attached with similar notations, and an explanation of the portions will be omitted.

The confocal microscope of the fourth embodiment shown in FIG. 7 is different from the confocal microscope of the first embodiment shown in FIG. 1 in the following. A camera 30 picks up the image of the observed sample 9 in place of the configuration of observing the observed sample 9 by the naked eye of the observer. A period of taking the image by the camera and a period of scanning by the double face mirror are made to coincide with each other.

A camera 30 is disposed such that an image taking face of CCD coincides with the image face 17 to acquire an observed image of the observed sample 9. A double face mirror driving circuit 31a makes the double face mirror 7 scan a focal point position of the illumination light 2 on the observed sample 9 by outputting a position control signal 32 and rotating the double face mirror 7 at a predetermined speed by a DC motor, not illustrated. The double face driving means 31a and the DC motor constitute a mirror driving section. Further, the double face mirror driving circuit 31a outputs a double face mirror rotational position signal 33 indicating a rotational position of the double face mirror 7 based on an output of a rotational sensor, not illustrated, (for example, a rotary encoder attached to the rotating shaft of the double face mirror 7) and the rotational position signal 33 is inputted to the camera 30 as a synchronization signal for determining the image taking period of the camera 30.

By the above-described, the image taking period of the camera 30 and the scanning period of the observed sample 9 by the illumination light 2 can be made to coincide with each other. Therefore, the observed image without non-uniformity in scanning can be provided.

### Fifth Embodiment

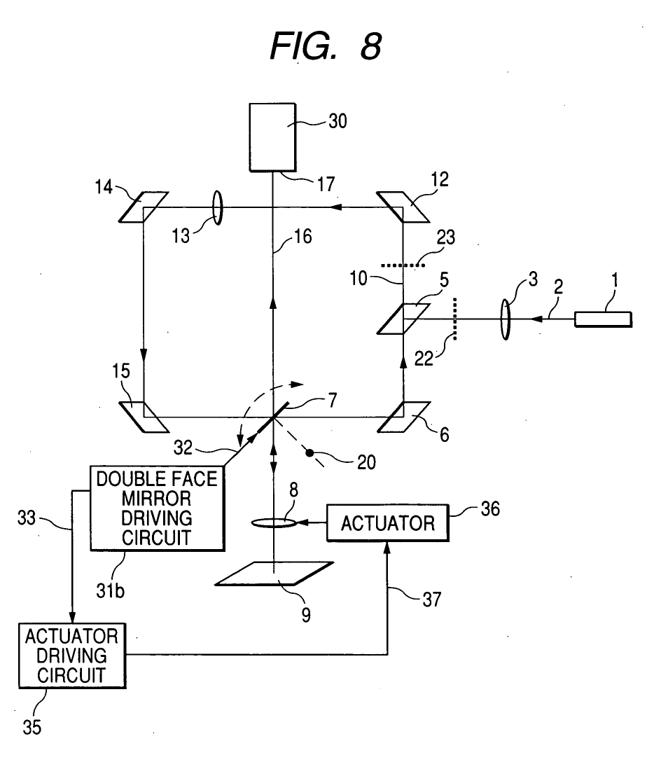

FIG. 8 is a configuration view showing a fifth embodiment of the confocal microscope according to the invention. Constituent elements similar to those of the previous drawings are attached with similar notations, and an explanation thereof will be omitted.

The confocal microscope of the fifth embodiment shown in FIG. 8 is different from the confocal microscope of the first embodiment shown in FIG. 1 in that the camera 30 picks up slice images at respective positions in an optical axis direction of the observed sample 9 by reciprocating to move the object lens 8 along an optical axis direction, and a period of rotating the double face mirror 7 and the period of moving the object lens 8 in the optical axis direction are made to coincide with each other.

A double face mirror driving circuit 31b makes the double face mirror scan the focal point position of the illumination light 2 on the observed sample 9 by outputting a position control signal 32 and rotating the double face mirror 7 at a predetermined speed by a DC motor, not illustrated. The double face mirror driving circuit 31b and the DC motor constitute a mirror driving section. Further, the double face mirror driving circuit 31b outputs the double face mirror rotational position signal 33 indicating the rotational position of the double face mirror 7 and the double face mirror rotational position signal 33 is inputted to an actuator driving circuit 35.

The actuator driving circuit 35 comprises, for example, an arbitrary waveform generator and an actuator driver, the arbitrary waveform generator outputs an analog waveform signal based on previously set waveform data, and the actuator driver outputs an actuator drive signal 37 in proportion to the analog waveform signal. The arbitrary waveform generator makes a scanning period by the double face mirror 7 and a period of an analog waveform constituting a basis of the actuator drive signal 37 coincide with each other based on the double face mirror rotational position signal 33. An actuator 36 comprises, for example, a piezoelectric element for moving the object lens 8 in the optical axis direction in accordance with the actuator drive signal 37.

The actuator driving circuit 35, the arbitrary waveform generator and the actuator driver constitute a control section for controlling a distance between the object lens and the observed sample 9.

By the above-described, the scanning period by the double face mirror 7 and the period of the actuator drive signal can be made to coincide with each other. Therefore, the observed image without non-uniformity in scanning can be provided.

Further, although the embodiment is constructed by the configuration of moving the object lens 8, a side of a stage (not illustrated) mounted with the observed sample 9 may be moved in the optical axis direction.

Further, although not illustrated, the actuator 36 is provided with a displacement sensor and control of the position of the object lens 8 is carried out by feeding back an output of the displacement sensor to the actuator driving circuit 35. Based on the output of the displacement sensor, a displacement signal indicating the distance between the object lens 8 and the observed sample 9 is outputted by the actuator driving circuit 35 and is inputted to the double face mirror driving circuit 31b. The scanning period by the double face mirror and the period of the actuator drive signal may be made to coincide with each other by using the inputted displacement signal by the double face mirror driving circuit 31b.

Although similarly not illustrated, by combining the embodiment of FIG. 7 and the embodiment, there may be constructed a configuration of making the image taking period of the camera 30, the period of moving the object lens 8 and the scanning period by the double face mirror 7 coincide with each other.

Further, a synchronization signal (for example, a vertical synchronization signal) of the camera may be inputted to the double face mirror driving circuit and the actuator driving circuit and the image taking period, the scanning period by the double face mirror and the actuator drive signal period may be made to coincide with each other based on the synchronization signal.

### Sixth Embodiment

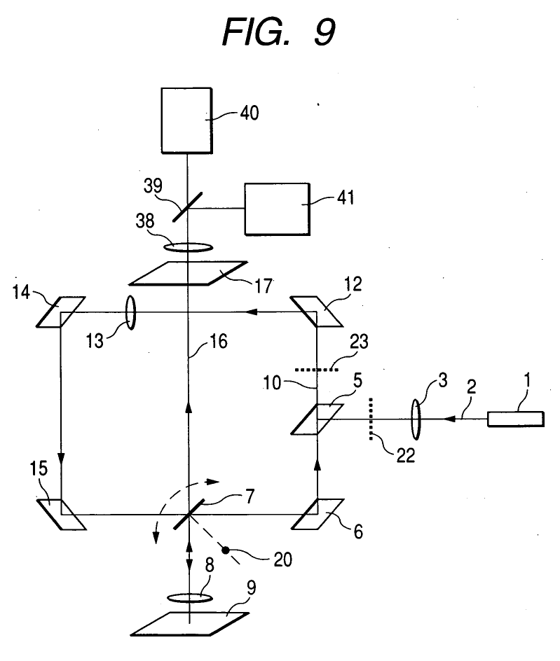

FIG. 9 shows a configuration view showing a sixth embodiment of the confocal microscope according to the invention. Constituent elements similar to those of the previous drawings are attached with similar notations, and an explanation of the portions will be omitted.

The confocal microscope of the sixth embodiment shown in FIG. 9 is different from the confocal microscope of the first embodiment shown in FIG. 1 in the following. Cameras 40, 41 pick up the image of the observed sample 9 in place of the configuration of observing the observed sample 9 by the naked eye of the observer. The observation light 10 from the observed sample 9 is divided the observation light by a dichroic mirror 39, then each of cameras 40, 41 picks up the observed image based on the observation light divided by the dichroic mirror 39.

A relay lens 38 prolongs the microscope observation light path 16 and transmits the optical image of the image face 17 to the dichroic mirror 39. The dichroic mirror 39 divides light of the transmitted optical image by a spectroscopic characteristic of its own, outputs the divided light to cameras 40, 41. Then, each of the cameras 40, 41 pick up the observed images. Thereby, multicolor observation of the observed sample 9 is realized. Although according to the embodiment, the optical image is divided into spectra of 2 colors, for example, a color image can be acquired by taking and synthesizing the spectra optical images divided into spectra of R (red), G (green), B (blue).

Further, the invention is not limited to the above-described embodiments but includes further numbers of changes and modifications within the range not deviated from the essence.

What is claimed is:

1. A confocal microscope for reflecting illumination light by a mirror to focus on a focal point face of a sample through an object lens, rotating the mirror to scan a focal point of the illumination light, and providing a confocal image based on returned light from the sample, the confocal microscope comprising:
a first multipinhole array which has a plurality of pinholes, and to which light emitted from a light source is illuminated; and
a second multipinhole array which has a plurality of pinholes, and intercepts light from other than the focal point face out of the returned light from the sample,
wherein the first multipinhole array functions as a plurality of point light sources, and
the illumination light is light which passes through the pinholes of the first multipinhole array.

2. The confocal microscope according to claim 1, further comprising:
a multilens array which is disposed on an optical path between the first multipinhole array and the light source, and has a plurality of microlenses which converge the light emitted from the light source,
wherein multilens array is disposed at a position where each microlens corresponds to each pinhole of the first multipinhole array.

3. The confocal microscope according to claim 1,
wherein the mirror includes a reflector at a position where a rotation axis of the mirror is located.

4. The confocal microscope according to claim 1,
wherein the mirror is a polygonal mirror.

5. The confocal microscope according to claim 1, further comprising:
a rotation sensor which outputs a rotational position signal indicating a rotational position of the mirror; and
a control section which moves at least one of the object lens and a stage on which the sample is placed in an optical axis direction, in synchronization with rotation of the mirror, based on the rotational position signal.

6. The confocal microscope according to claim 1, further comprising:
a control section which moves at least one of the object lens and a stage on which the sample is placed in an optical axis direction;
a displacement sensor which outputs a displacement signal when at least one of the object lens and the stage is moved; and
a mirror driving section which rotates the mirror in synchronization with a displacement between the object lens and the sample based on the displacement signal.

7. The confocal microscope according to claim 1, further comprising:
a rotation sensor which outputs a rotational position signal indicating a rotational position of the mirror; and
a camera which picks up the confocal image in synchronization with rotation of the mirror based on the rotational position signal.

8. The confocal microscope according to claim 1, further comprising:
a control section which moves at least one of the object lens and a stage on which the sample is placed in an optical axis direction;
a displacement sensor which outputs a displacement signal when at least one of the object lens and the stage is moved; and
a camera which picks up the confocal image in synchronization with a displacement between the object lens and the sample based on the displacement signal.

9. The confocal microscope according to claim 1, further comprising:
a camera which picks up the confocal image; and
a mirror driving section which rotates the mirror in synchronization with an imaging by the camera based on a synchronization signal output from the camera.

10. The confocal microscope according to claim 1, further comprising:
the camera which picks up the confocal image; and
a control section which moves at least one of the object lens and a stage on which the sample is placed in an optical axis direction, in synchronization with an imaging by the camera, based on a synchronization signal output from the camera.

11. The confocal microscope according to claim 1, further comprising:
a dichroic mirror which dividing the returned light; and
a plurality of cameras which picks up each confocal image based on the returned light divided by the dichroic mirror.
